(19) United States
(12) Patent Application Publication
(10) Pub. No.: US 2014/0225516 A1
(43) Pub. Date: Aug. 14, 2014

(54) Wireless lighting system

(71) Applicant: YuYu Chen, Foster City, CA (US)

(72) Inventor: YuYu Chen, Foster City, CA (US)

(73) Assignee: E3CONTROL. INC

(21) Appl. No.: 13/815,196

(22) Filed: Feb. 9, 2013

(51) Int. Cl. H05B 37/02

(52) U.S. Cl. CPC H05B 37/0272; H05B 37/0227
USPC 315/155

(57) ABSTRACT

A wireless lighting system, which contains one or more sensor devices and one or more lighting clients. The sensor devices detect actionable events such as movement in a monitored zone and are capable of transmitting a message which is received by the lighting clients. Each lighting client has unique operating characteristics in configured by the end user. A lighting client receives operating input voltage via a standard male screw base such as a standard Edison E27 mm male adapter. A lighting client provides operating voltage to a standard bulb via a female screw receptacle such as a standard Edison E27 mm female adapter. Examples of bulb types include incandescent, LED-based, and compact fluorescent bulbs.

### BACKGROUND OF THE INVENTION

The present invention relates to a system and method for controlling a plurality of lighting elements, each lighting having an individually configurable lighting behavior.

A vast majority of lighting fixtures in a residential environment are not automated. Dimmer switches are used to control the light output intensity of all the bulbs coupled to the input voltage controlled by the same dimmer switch.

Another lighting control scheme that is commonly implemented is the use of a switch timer connected to the AC mains, which provides an AC output voltage to a light fixture (or other electrical device) at preset times. By connecting a lighting fixture set to the ON position to the switch timer, the light fixture will be turned “ON” during the times the switch timer is preset to be in the ON position. End users for a variety of purposes employ switch timers to control a lighting fixture. One of the main reasons includes home security. For example, end users employ switch timers to control the turning ON and OFF of a light fixture while they are away from the home is to make it appear that the home is occupied to deter unauthorized individuals from entering into the home.

Another example of a commonly used lighting control system is a self-contained motioned detector controlled light fixture. In this case, a self-contained system is connected to an external power source such as the AC power mains. A motion detection device senses movement in a specific zone, typically using an infrared sense device. Once the motion sense device has detected movement, the system places the light fixture to the ON position for a predetermined period of time.

In order to provide end users with a greater functionality, a wide range of home automation systems are available. Automated lighting systems are common on large commercial structures, as they allow greater control over the indoor environment. Unfortunately, current home automation systems are relatively expensive. Moreover, installing a home automation system, including retrofitting the existing infrastructure, is far beyond the capabilities of most homeowners. Unless the homeowner has specialized training, it is necessary to hire a specially trained technician to install and configure the system. Initial purchase and installation costs, as well as the complexity to configure and maintain a home automation system has severely limited the growth of zoned HVAC systems in the home market.

### SUMMARY OF INVENTION

In general, the object of the present invention is to provide methods and apparatus of a lighting system capable of controlling a plurality of lighting clients. The end user determines the operational characteristics of individual lighting clients. The lighting system also contains sensor devices, which monitor and detect movement in a specified zone, resulting in an actionable event. When a sensor device detects an actionable event, the lighting clients are notified via wireless communications. Once notified that an actionable event has occurred, each lighting client takes the appropriate action based on the configuration options chosen by the end user.

A non-limiting embodiment of the present invention includes a system of the present invention where the lighting system includes one or more sensor devices and one or more lighting clients.

A non-limiting embodiment of the present invention includes the sensor devices of the present invention where it determines an actionable event based on detected movement in a specified zone.

A non-limiting embodiment of the present invention includes the lighting client of the present invention where the end user may define the length of delay between receiving a notification of an actionable event and changing the light output intensity from a first level to a second level.

A non-limiting embodiment of the present invention includes the lighting client of the present invention where the end user may define the length of time between changing the light output intensity from a second level to a first level.

A non-limiting embodiment of the present invention includes the lighting client of the present invention capable of providing dimming capabilities, allowing for the programmability of the light output intensity at the various operating states.

A non-limiting embodiment of the present invention includes the lighting client of the present invention where the light output intensity is controlled using phase angle switching.

A non-limiting embodiment of the present invention includes the lighting client of the present invention containing an over-ride switch.

### BRIEF DESCRIPTION OF THE DRAWINGS

FIG. 1. describes a wireless lighting system as per one embodiment of the present invention

FIG. 2. describes a block diagram of a sensor device and a block diagram of lighting clients as per one embodiment of the present invention.

FIG. 3. describes a block diagram of a lighting client as per one embodiment of the present invention.

FIG. 4. illustrates the operation waveforms of a lighting client as per one embodiment of the present invention.

FIG. 5. illustrates the operating characteristics of a lighting client as per one embodiment of the present invention.

FIG. 6. describes a lighting client as per one embodiment of the present invention.

### DETAILED DESCRIPTION OF THE DRAWINGS

In the following description, reference is made to the accompanying drawings which form a part hereof, and which is shown, by way of illustration, several embodiments of the present invention. It is understood that other embodiments may be utilized and structural changes may be made without departing from the scope of the present invention.

In general, the object of the present invention is to provide methods and apparatus of a lighting system capable of controlling a plurality of lighting clients. The end user determines the operational characteristics of individual lighting clients. The lighting system also contains sensor devices, which monitor and detect movement in a specified zone, resulting in an actionable event. When a sensor device detects an actionable event, the lighting clients are notified via wireless communications. Once notified that an actionable event has occurred, each lighting client takes the appropriate action based on the configuration options chosen by the end user.

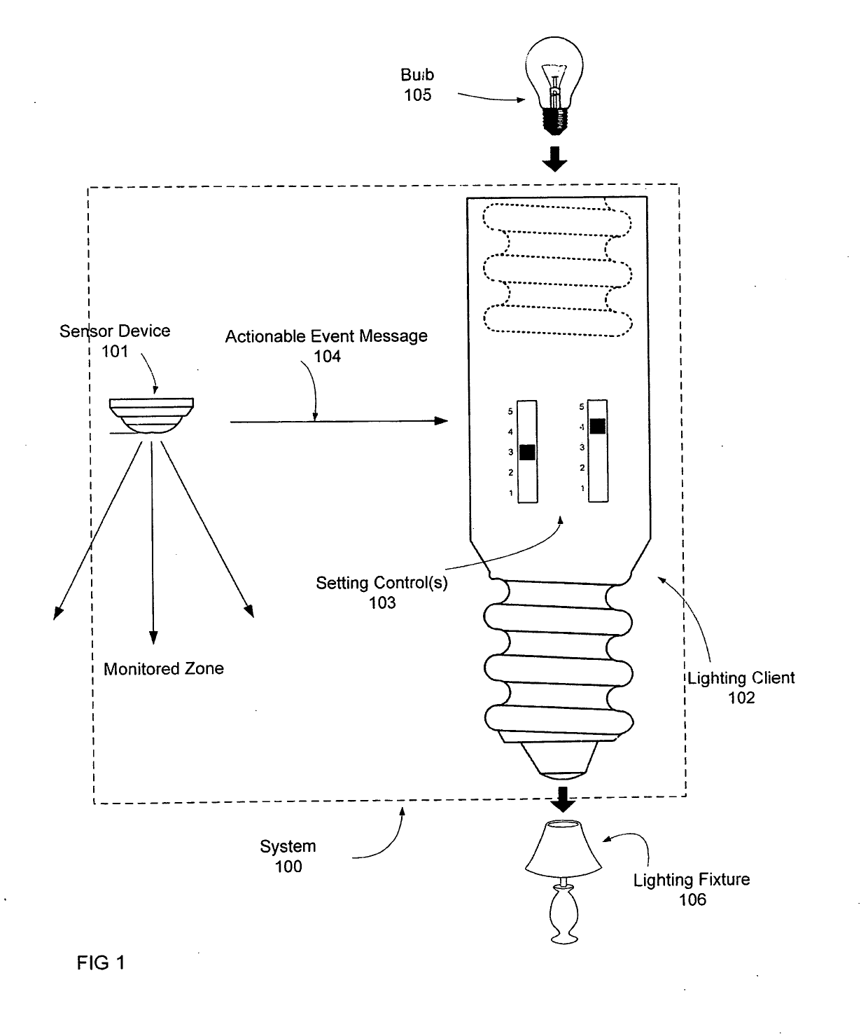

FIG. 1 shows the system level components of the present invention. Lighting system 100 consists of two major elements, sensor device 101 and lighting client 102. Lighting system 100 may consist of one or more sensor devices and one or more lighting clients. Sensor device 101 is generally responsible to monitor a specific zone for an actionable event. This may include, but not limited to the detection of movement via a motion detection sensor. Once sensor device has detected an actionable event has been detected, and actionable event message 104 is transmitted from sensor device 101 and received by lighting client 102. Lighting client 102 is coupled to the AC mains via lighting fixture 106. Although lighting fixture 106 may contain an ON/OFF switch, it is typically left in the ON position, allowing lighting client 102 to have a direct connection to the AC mains. Lighting client 102 interfaces with lighting fixture 106 via a standard male screw base, such as a standard Edison E27 mm male adapter. Lighting client 102 is also coupled to bulb 105. Lighting client 102 provides operating voltage to a standard bulb via a female screw receptacle such as a standard Edison E27 mm female adapter. Examples of bulb types include incandescent, LED-based, and compact fluorescent bulbs. Lighting client 102 controls the light output intensity of bulb 105 by controlling the AC input voltage input to bulb 105. The operating characteristics of bulb 105 is based on receiving actionable event message 104 is determined by the end user using setting controls 103. The end user can individually set the operating characteristics of each lighting client in lighting system 100.

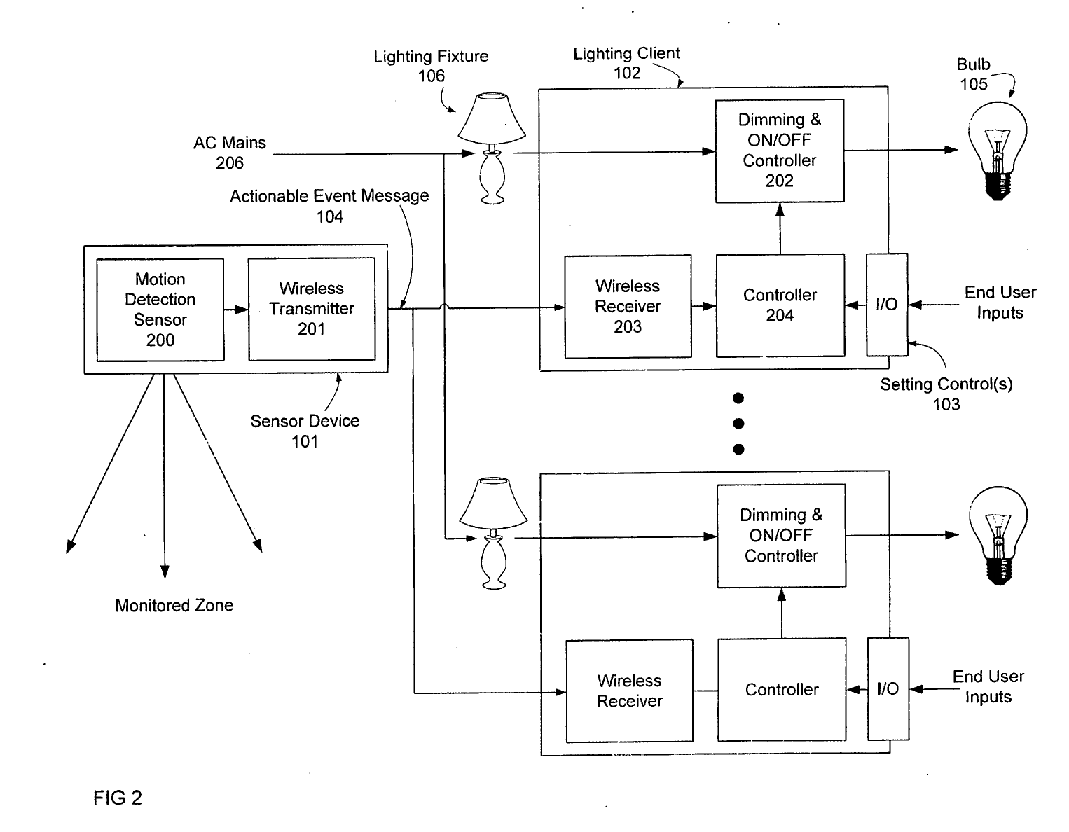

FIG. 2 illustrates non-limiting examples of the block diagrams of the key components of the lighting system of the present invention. Sensor device contains motion detection sensor 200, which determines if an actionable event has occurred. In this case, detected motion within a monitored zone. If an actionable event has been detected, an actionable event message is generated and transmitted by wireless transmitter 210. All lighting clients receive actionable event message 104. Non-limiting examples of wireless technologies employed include Wi-Fi and Zigbee. As an example, lighting client 102 receives actionable event message 104 via wireless receiver 203. As mentioned, the end user via setting(s) control 103 configures the operational characteristics of individual lighting clients. Examples of the input/output devices used for setting(s) control 103 include but are not limited to slider switches, buttons, and dials. Controller 104 is responsible to control the light output intensity emitted by bulb 105 during all operating conditions. For example, when an actionable event has been received, controller 204 determines what change in the light output intensity of bulb 105 the end user desires. Controller 104 uses dimming & ON/OFF controller 202 to control the light output intensity of bulb 105. As lighting client is couple to AC mains 106 via lighting fixture 106, dimming & ON/OFF controller 202 adjusts the light output intensity by controlling the input voltage to bulb 105.

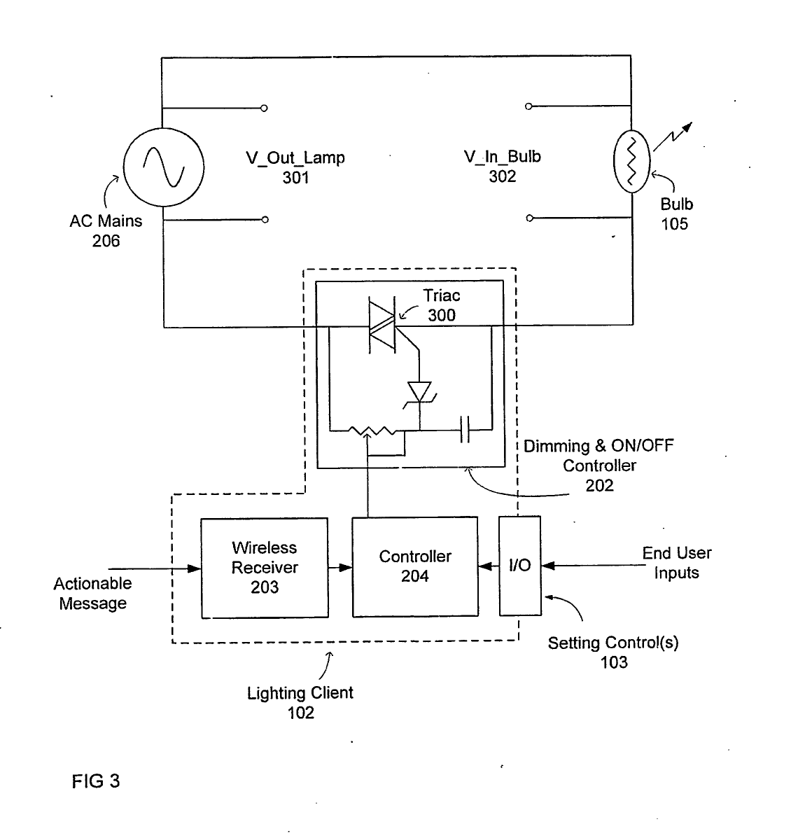

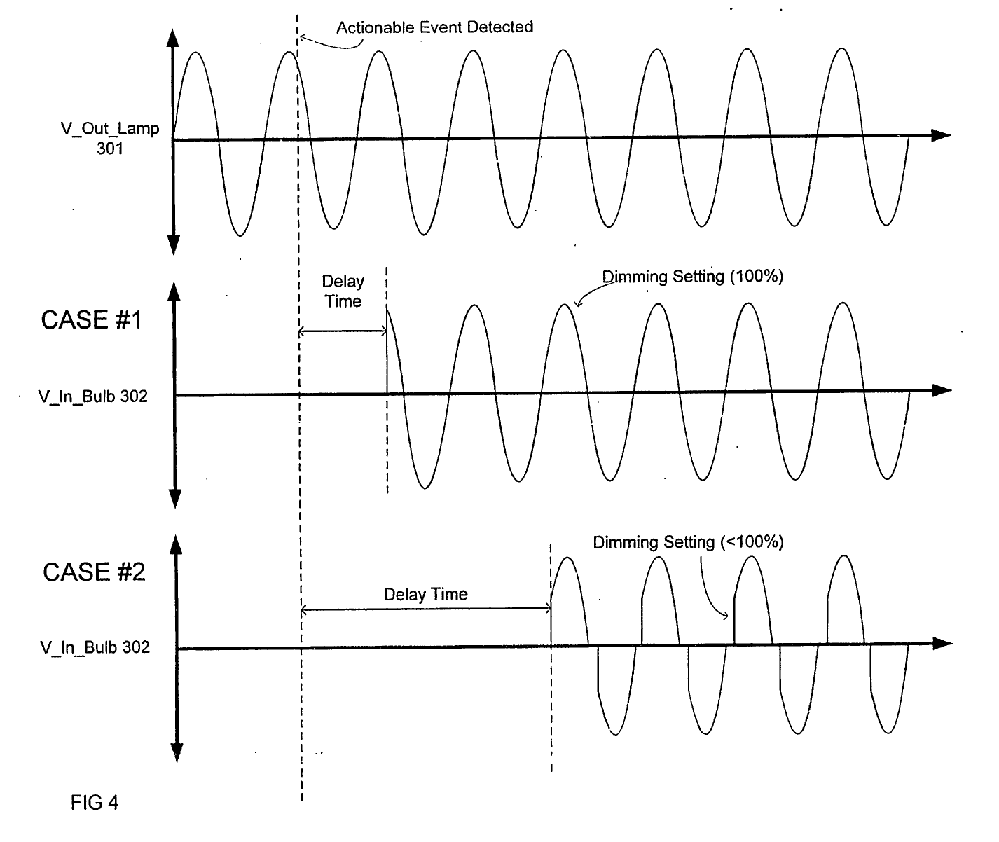

FIG. 3 illustrates a non-limiting example of a block diagram of lighting client 102 with greater detail of dimming and ON/OFF controller 202. As mentioned, dimming & ON/OFF controller 202 adjusts the light output intensity by controlling the input voltage to bulb 105. The adjustment is made based on an input signal from controller 204. Dimming & ON/OFF controller 202 adjusts the input voltage to bulb 105 V_In_bulb 302 via phase angle switching. Triac device 300 is used to couple or un-couple bulb 105 from the AC mains in order to control the light output intensity. The light out put intensity may be adjusted from 0% to 100% of bulb 105 rated light output intensity. FIG. 4 further illustrates the operational waveforms regarding dimming & ON/OFF controller 202. V_Out_Lamp 301 shows the output voltage of lighting fixture 106. Since lighting fixture 106 in the ON position and is coupled to AC mains 206, AC mains 206 and V_Out_Lamp 301 can be considered coupled. As shown by Case #1, prior to receiving an actionable event message, the input voltage to bulb 105 V_In_Bulb 302 is in the OFF state. When an actionable event has been detected, controller 204 determines that the light output intensity of bulb 105 should be set to 100% after a short time delay. The 100% light output intensity of bulb 105 and the length of the time delay may be set by the end user via the setting controls. The light intensity of bulb 105 is 100% as the full AC wavform of V_Out_Lamp 301 is coupled to bulb 105. The end user via the setting controls may also set the length of time that V_In_Bulb 302 remains in the ON position. Similarly, as shown by Case #2, prior to receiving an actionable event message, the input voltage to bulb 105 V_In_Bulb 302 is in the OFF state. When an actionable event has been detected, controller 204 determines that the light output intensity of bulb 105 should be set to a dimming level (<100% light output intensity) after a short time delay. The amount of dimming while in the ON state (<100% light output intensity) of bulb 105 and the length of the time delay may be set by the end user via the setting controls. The light intensity of bulb 105 is slightly dimmed (<100% light output intensity) as a portion of the AC wavform of V_Out_Lamp 301 is phase switched by dimming & ON/OFF controller 202. The end user via the setting controls may also set the length of time that V_In_Bulb 302 remains in the ON position.

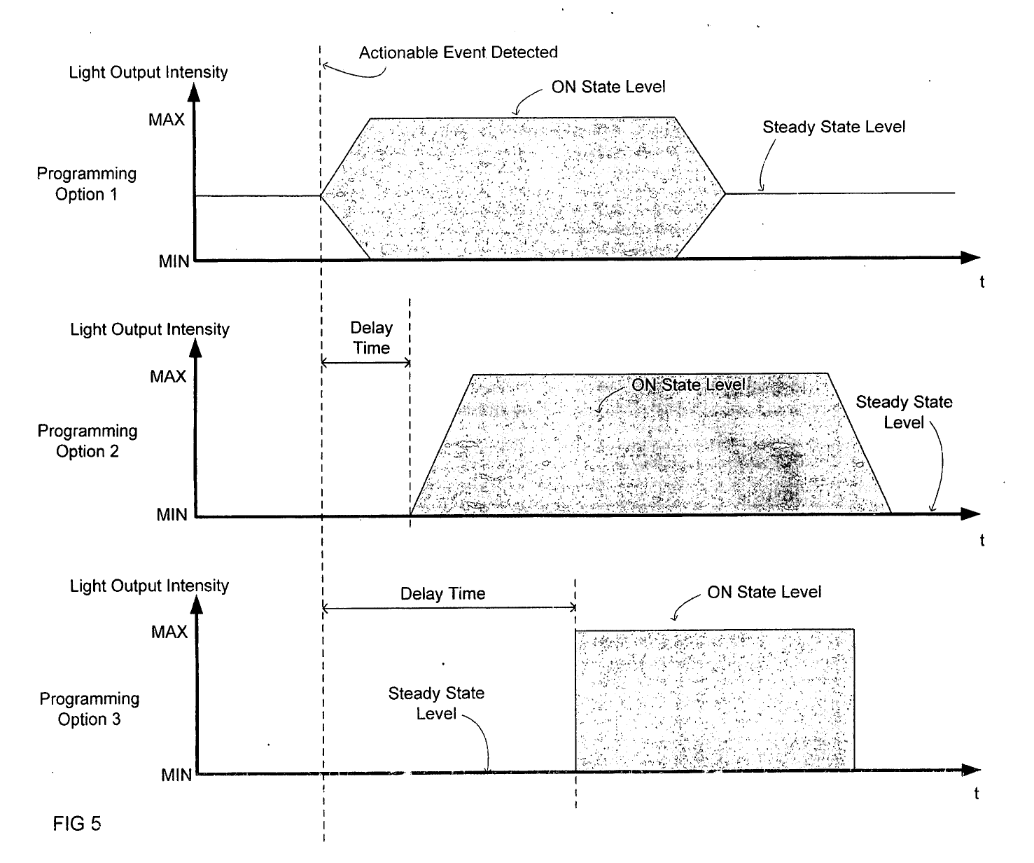

FIG. 5 illustrates non-limiting examples of the operating characteristics that may be controlled by lighting clients. As shown by programming Option 1, the steady state light output intensity of bulb 105 is set to a dimmed setting (<100% light output intensity). The steady state level is defined as the light output intensity prior to when an actionable event is detected. Once an actionable event has been detected, the light output intensity if bulb 105 may be changed from 0% to 100% (ON state) of the rated light output intensity rating of bulb 105. The light output intensity may be changed as a step function, or gradually as shown. The length of time of the light output intensity remains at this level is also configurable. As shown by programming Option 2, the steady state light output intensity of bulb 105 is set to the OFF state (0% light output intensity). The steady state level is defined as the light output intensity prior to when an actionable event is detected. Once an actionable event has been detected, the light output intensity if bulb 105 may be changed from >0% to 100% (ON state) of the rated light output intensity rating of bulb 105 after a time delay. The light output intensity may be changed as a step function, or gradually as shown. The initial delay time and length of time of the light output intensity remains at this level is also configurable. As shown by programming Option 3, the steady state light output intensity of bulb 105 is set to the OFF state (0% light output intensity). The steady state level is defined as the light output intensity prior to when an actionable event is detected. Once an actionable event has been detected, the light output intensity if bulb 105 may be changed from >0% to 100% (ON state) of the rated light output intensity rating of bulb 105 after a time delay. The light output intensity may be changed gradually, or as a step function as shown. The initial delay time and length of time of the light output intensity remains at this level is also configurable.

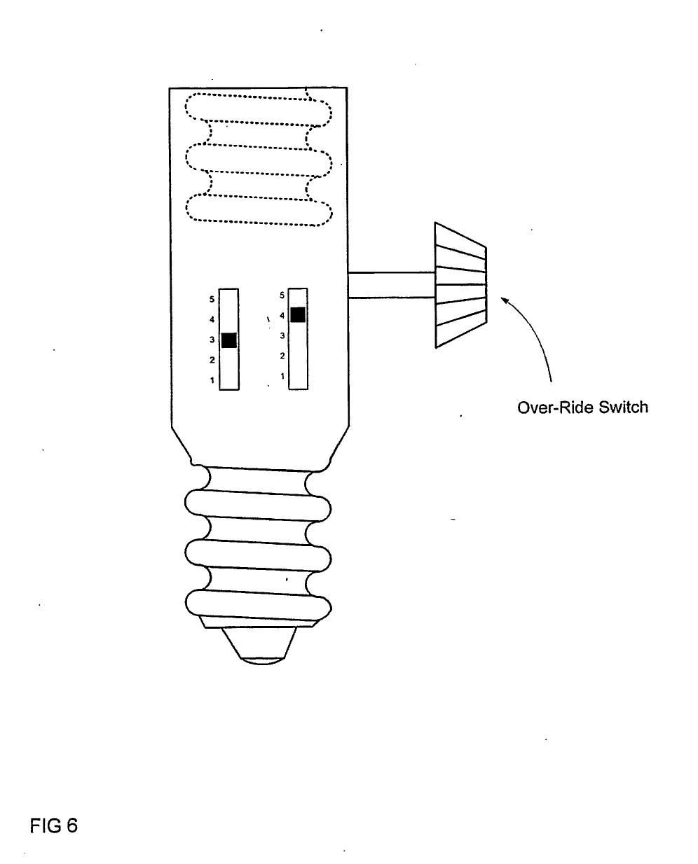

FIG. 6 illustrates that each lighting client may contain an over-ride mode which the end user can manually place the bulb in the ON or OFF position.

What is claimed:

1. A lighting system comprising:
One or more sensor devices capable of
Detecting an actionable event, including movement in a monitored zone, and
Transmitting a wireless message when an actionable even has been detected,
One or more lighting clients capable of
Receiving as wireless message indicating an actionable event from a sensor device,
Interfacing the AC mains via a standard bulb male connector,
Interfacing a standard bulb via a standard bulb female connector,
Adjusting the input voltage supplied to the bulb to control the light output intensity,
Adjusting the operating characteristics when an actionable event has been detected based on end user defined configuration.

2. A lighting system of claim 1 where the end use defines the light output intensity of a bulb using setting controls located on each lighting client.

3. A lighting system of claim 2 where the light output intensity of a bulb prior to detecting an actionable event is defined by an end user using setting controls located on each lighting client.

4. A lighting system of claim 2 where the light output intensity of a bulb once an actionable event has been detected is defined by an end user using setting controls located on each lighting client.

5. A lighting system of claim 2 which employs AC phase switching to control the light output intensity of a bulb.

6. A lighting system of claim 1 where the lighting client employs AC phase switching to control the light output intensity of the bulb.

7. A lighting system of claim 2 where a time delay between the time when an actionable event is detected and the light output intensity of a bulb is adjusted is defined by an end user using setting controls located on each lighting client.

8. A lighting system of claim 2 where the time the light output intensity of a bulb is changed in response to the detection of an actionable event is defined by an end user using setting controls located on each lighting client.

9. A lighting system of claim 1 where a lighting client comprises an over-ride switch where an end user may turn ON or OFF a bulb independent of detecting an actionable event.
